(19) United States
(12) Patent Application Publication
(10) Pub. No.: US 2026/0247121 A1
(43) Pub. Date: Aug. 20, 2026

(54) METHOD AND DEVICE FOR PERFORMING UWB RANGING

(71) Applicant: Samsung Electronics Co., Ltd., Suwon-si, Gyeonggi-do (KR)

(72) Inventors: Junyoung CHOI, Suwon-si (KR); Yeonju LIM, Suwon-si (KR)

(21) Appl. No.: 19/162,159

(22) PCT Filed: Mar. 6, 2023
(86) PCT No.: PCT/KR2023/003045

§ 371 Date: Sep. 4, 2025

(51) Int. Cl. H04W 4/80; H04W 4/02

(52) U.S. Cl. CPC H04W 4/80; H04W 4/023

(57) ABSTRACT

A method for operating an electronic device supporting ultra wide band (UWB) communication according to an embodiment of the present invention may comprise the operations of: transmitting a first message to at least one external electronic device that has performed first UWB ranging with the electronic device, the first message being transmitted through Bluetooth Low Energy (BLE); adjusting at least one of the search distance or search angle for external electronic devices in response to a user input; transmitting a second message to the external electronic devices through the BLE on the basis of the adjustment result; receiving a third message, corresponding to the second message, from at least one of the external electronic devices; and performing second UWB ranging with the at least one external electronic device that transmitted the third message.

### TECHNICAL FIELD

The disclosure relates to ultra-wideband (UWB) communication and, more specifically, to a method for performing UWB ranging.

### BACKGROUND ART

The Internet is evolving from the human-centered connection network by which humans create and consume information to the Internet of Things (IOT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wide band (UWB). UWB is a wireless communication technology that uses a very wide frequency band of several GHz or more in a baseband without using a wireless carrier.

### DETAILED DESCRIPTION OF THE INVENTION

### Technical Problem

The disclosure proposes a method for an electronic device supporting ultra-wideband (UWB) communication to perform UWB ranging with an external electronic device.

### Technical Solution

According to an embodiment of the disclosure, a method for operating an electronic device supporting ultra-wideband (UWB) communication may comprise transmitting a first message via Bluetooth low energy (BLE) communication to at least one external electronic device that has performed first UWB ranging with the electronic device, adjusting at least one of a discovery distance and a discovery angle for external electronic devices in response to a user input, transmitting a second message via the BLE communication to the external electronic devices based on a result of the adjustment, receiving a third message corresponding to the second message from at least one of the external electronic devices, and performing second UWB ranging with the at least one external electronic device that transmitted the third message.

According to an embodiment of the disclosure, a method for operating an electronic device supporting ultra-wideband (UWB) communication may comprise receiving a first message via Bluetooth low energy (BLE) communication from an external electronic device that has performed first UWB ranging, receiving a second message via the BLE communication from the external electronic device if at least one of a discovery distance and a discovery angle of the external electronic device is adjusted in response to a user input of the external electronic device, determining whether the electronic device has moved based on a sensor measurement value or a BLE received signal strength indicator (RSSI) value, transmitting a third message corresponding to the second message to the external electronic device if it is determined that the electronic device has moved, and performing second UWB ranging with the external electronic device.

According to an embodiment of the disclosure, an electronic device supporting ultra-wideband (UWB) communication may comprise a transceiver and a processor. The processor may control to transmit a first message viaBluetooth low energy (BLE) communication to at least one external electronic device that has performed first UWB ranging with the electronic device, adjust at least one of a discovery distance and a discovery angle for external electronic devices in response to a user input, control to transmit a second message via the BLE communication to the external electronic devices based on a result of the adjustment, receive a third message corresponding to the second message from at least one of the external electronic devices, and perform second UWB ranging with the at least one external electronic device that transmitted the third message.

According to an embodiment of the disclosure, an electronic device supporting ultra-wideband (UWB) communication may comprise a transceiver and a processor. The processor may receive a first message via Bluetooth low energy (BLE) communication from an external electronic device that has performed first UWB ranging, receive a second message via the BLE communication from the external electronic device if at least one of a discovery distance and a discovery angle of the external electronic device is adjusted in response to a user input of the external electronic device, determine whether the electronic device has moved based on a sensor measurement value or a BLE received signal strength indicator (RSSI) value, control to transmit a third message corresponding to the second message to the external electronic device if it is determined that the electronic device has moved, and perform second UWB ranging with the external electronic device.

### Advantageous Effects

A UWB device according to an embodiment of the disclosure may reduce the power consumption of the UWB device by appropriately initiating a UWB ranging operation.

### BRIEF DESCRIPTION OF DRAWINGS

FIG. 1 illustrates an example architecture of an electronic device according to an embodiment of the disclosure;

FIG. 2 illustrates a communication system including a plurality of electronic devices according to an embodiment of the disclosure;

FIG. 3 illustrates a method for performing communication by a plurality of electronic devices according to an embodiment of the disclosure;

FIG. 4 illustrates a process in which an electronic device adjusts a distance range from a target electronic device using a pinch zoom function according to an embodiment of the disclosure;

FIG. 5 illustrates a process in which an electronic device performs UWB ranging with at least one external electronic device according to an embodiment of the disclosure;

FIG. 6 illustrates an embodiment in which an electronic device performs a zoom-in operation, according to an embodiment of the disclosure;

FIG. 7 illustrates an example in which an electronic device performs a zoom-out operation according to an embodiment of the disclosure;

FIG. 8 illustrates an example of a process in which an electronic device performs SS-TWR, according to an embodiment of the disclosure;

FIG. 9 illustrates a process in which a plurality of electronic devices perform sensing-based distance search according to an embodiment of the disclosure;

FIG. 10 illustrates a process in which an electronic device performs ranging and/or AoA during a sensing-based distance search according to an embodiment of the disclosure;

FIG. 11 illustrates a process in which an electronic device adjusts a search distance through SS-TWR according to an embodiment of the disclosure;

FIG. 12 illustrates a process in which an electronic device performs sensor-based search readjustment according to an embodiment of the disclosure;

FIGS. 13A and 13B illustrate an example describing a process in which an electronic device determines mobility based on a sensor, according to an embodiment of the disclosure;

FIG. 14 illustrates a process in which a plurality of electronic devices perform BLE-based distance search according to an embodiment of the disclosure;

FIG. 15 illustrates a process in which an electronic device performs ranging and/or AoA during a BLE-based distance search according to an embodiment of the disclosure;

FIG. 16 illustrates a process in which an electronic device performs BLE-based search readjustment according to an embodiment of the disclosure;

FIG. 17 illustrates an example for describing a process in which an electronic device determines mobility based on BLE, according to an embodiment of the disclosure;

FIG. 18 illustrates a process in which a plurality of electronic devices perform an initial sharing-based additional sharing distance search, according to an embodiment of the disclosure;

FIG. 19 illustrates a structure of a first electronic device according to an embodiment of the disclosure; and FIG. 20 illustrates a structure of a second electronic device according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

As used herein, the term ‘electronic device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the electronic device may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the electronic device may include a machine to machine (M2M) terminal and a machine-type communication (MTC) terminal/device, but is not limited thereto. In the disclosure, the electronic device may be referred to as a terminal or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present invention are described in detail with reference to the accompanying drawings. Further, although a communication system using UWB is described in connection with embodiments of the present invention, as an example, embodiments of the present invention may also apply to other communication systems with similar technical background or features. For example, a communication system using Bluetooth or ZigBee may be included therein. Further, embodiments of the present invention may be modified in such a range as not to significantly depart from the scope of the present invention under the determination by one of ordinary skill in the art and such modifications may be applicable to other communication systems.

When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wideband (UWB). A wireless network in which such a wireless network technology is implemented may include a plurality of electronic devices.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“UWB message” may be a message including a payload IE transmitted by the UWB device (e.g., enhanced ranging device (ERDEV)).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“UWB channel” may be one of candidate UWB channels allocated for UWB communication. Candidate UWB channels allocated for UWB communication may be channels allocated for UWB communication defined in IEEE 802.15.4/4z. The UWB channel may be used for UWB ranging and/or transaction. For example, the UWB channel may be used for transmission/reception of a ranging frame RFRAME and/or transmission/reception of a data frame.

“Narrow band (NB) channel” may be a channel having a narrower bandwidth than the UWB channel. The NB channel may be a subchannel of one of the candidate UWB channels allocated for UWB communication. Candidate UWB channels allocated for UWB communication may be channels allocated for UWB communication defined in IEEE 802.15.4/4z. The NB channel may be used for advertising, device discovery, and/or connection setup for additional parameter negotiation/authentication. For example, the NB channel may be used for transmission and reception of an advertisement message, an additional advertising message, a connection request message, and/or a connection confirmation message.

When determined to make the subject matter of the present invention unnecessarily unclear, the detailed description of related known functions or features may be skipped in describing the disclosure.

Hereinafter, various embodiments of the disclosure are described with reference to the accompanying drawings.

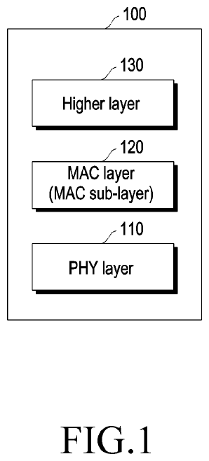

FIG. 1 illustrates an example architecture of an electronic device according to an embodiment of the disclosure.

In the disclosure, the electronic device may be one of various types of electronic devices. For example, the electronic device may be a portable device (e.g., a UE, a smartphone, a wearable device, a vehicle, or a tag device) or a stationary device (e.g., a door lock or an anchor device).

Referring to FIG. 1, the electronic device 100 may include a PHY layer 110, a MAC layer (MAC sublayer) 120, and/or a higher layer 130.

### (1) PHY Layer

The PHY layer 110 may include a low-level control entity and at least one transceiver. In this disclosure, the transceiver may be referred to as an RF transceiver or a radio transceiver.

As an embodiment, at least one transceiver may include a first transceiver supporting UWB communication (e.g., 802.15.4z-based UWB communication), a second transceiver supporting NB communication using a narrower bandwidth than that of UWB communication, and/or a third transceiver supporting other communication technologies (e.g., Bluetooth or BLE). In this disclosure, the first transceiver may be referred to as a UWB transceiver. The second transceiver may be referred to as an NB transceiver. The third transceiver may be referred to as an out-of-band (OOB) transceiver. According to embodiments, one transceiver may support a plurality of communication technologies. For example, one transceiver may support UWB communication and NB communication.

In an embodiment, the PHY layer 110 may support at least one of the following functions.
Transceiver activation and deactivation function (transceiver on/off function)
Energy detection function
Channel selection function
Clear channel assessment (CCA) function
Synchronization function
Low-level signaling function
UWB ranging, positioning and localization functions
Spectrum resource management function
Function to transmit/receive packets through physical medium

### (2) MAC Layer

The MAC layer 120 provides an interface between the higher layer 130 and the PHY layer 120.

In an embodiment, the MAC layer 120 may provide two services as follows.
MAC data service: A service that enables transmission and reception of MAC protocol data unit (PDU) through the PHY
MAC management service: Service interfacing to MAC sublayer management entity (MLME) service access point (SAP) (MLME-SAP)

In an embodiment, the MAC layer 120 may support at least one of the following functions.
Device discovery and connection setup function
Channel access function (function of access to physical channel (e.g., NB
channel/UWB channel/OOB channel))
Synchronization function
Interference mitigation function based on energy detection
Functions related to NB signaling
Guaranteed timeslot (GTS) management function
Frame delivery function
UWB ranging function
PHY parameter change notification function
Security function

### (3) Higher Layer

The higher layer 130 may include a network layer providing functions, such as network configuration and message routing, and/or an application layer providing an intended function of the device. In an embodiment, the application layer may be a UWB-enabled application layer for providing a UWB service.

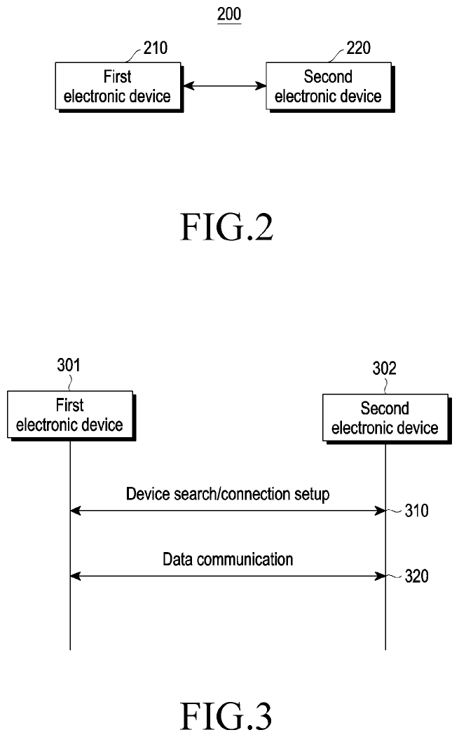

FIG. 2 illustrates a communication system including a plurality of electronic devices according to an embodiment of the disclosure.

Referring to FIG. 2, a communication system 200 may include a first electronic device 210 and a second electronic device 220. As an embodiment, the first electronic device 210 and/or the second electronic device 220 may be the electronic device 100 of FIG. 1.

The first electronic device 210 may communicate with the second electronic device 220 for device discovery, connection setup, ranging (e.g., UWB ranging), data communication, and/or other purposes.

The first electronic device 210 may communicate with the second electronic device 220 according to a preset communication scheme (technology). For example, the first electronic device 210 may perform wireless communication with the second electronic device 220 using a UWB communication scheme, an NB communication scheme, and/or an OOB communication scheme.

In the disclosure, the UWB communication scheme may perform communication through at least one of candidate UWB channels allocated for UWB communication.

NB communication may support at least one NB channel having a narrower bandwidth than the UWB channel. According to an embodiment, the NB channel may be a subchannel of one of the candidate UWB channels allocated for UWB communication.

FIG. 3 illustrates a method for performing communication by a plurality of electronic devices according to an embodiment of the disclosure.

The first electronic device 301 and the second electronic device 302 of FIG. 3 may be, e.g., the electronic devices of FIG. 1 or 2.

Referring to FIG. 3, the first electronic device 301 and the second electronic device 302 may perform a device search/connection setup procedure 310 and a data communication procedure 320. The device search/connection setup procedure 310 and data communication procedure 320 may be managed or controlled by the MAC layer (entity) of the electronic device.

### (1) Device Search/Connection Setup Procedure

In the disclosure, the device search/connection setup procedure 310 may be a prior procedure performed before the data communication procedure 320. As an example, the device discovery/connection setup procedure 310 may be performed over OOB communication (channel), NB communication (channel), and/or UWB communication (channel).

The device search/connection setup procedure 310 may include at least one of the following operations.
Device discovery operation: An operation in which the electronic device searches for (discovers) another UWB devices. The device discovery operation may include an operation for transmitting/receiving an advertisement message. In the disclosure, the device discovery operation may be referred to as a discovery operation or an advertising operation.
Connection setup operation: An operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (controlee performance parameters), UWB configuration parameters, session key-related parameters) for configuring a UWB session through a secure channel established through the connection setup operation may be negotiated between two electronic devices.

### (2) Data Communication Procedure

In the disclosure, the data communication procedure 320 may be a procedure for transmitting and receiving data using UWB communication. As an embodiment, the data communication procedure may be performed by UWB communication or NB communication.

The data communication procedure 320 may include at least one of the following operations.

UWB ranging operation: An operation in which the electronic device performs UWB ranging with another electronic device in a preset UWB ranging scheme (e.g., OWR, SS-TWR, DS-TWR scheme). As an embodiment, the UWB ranging operation may include a ToF measurement operation and/or an AoA measurement operation.

Transaction operation: An operation in which an electronic device exchanges service data with another electronic device.

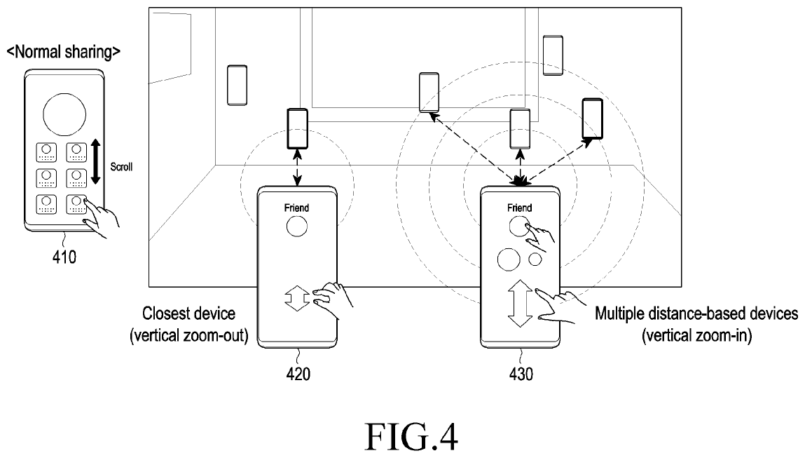

FIG. 4 illustrates a process in which an electronic device adjusts a distance range from a target electronic device using a pinch zoom function according to an embodiment of the disclosure.

The electronic devices 410 to 430 may be implemented as the electronic device 100 of FIG. 1, the first electronic device 210 of FIG. 2, the second electronic device 220 of FIG. 2, the first electronic device 301 of FIG. 3, or the second electronic device 302 of FIG. 3.

Referring to FIG. 4, the electronic device 410 may search for candidate electronic devices to share files in response to the user's scroll input, and may select a target electronic device to share files from among the candidate electronic devices in response to the user's touch input.

The electronic device 420 or the electronic device 430 may enlarge or reduce the screen in response to the user's pinch zoom input. The pinch zoom may mean a function of enlarging or reducing a screen through the user touch input (e.g., finger input) on a touch display of an electronic device (e.g., a smartphone or tablet). The pinch zoom may be an application programming interface (API) for screen movement.

The electronic device 420 or the electronic device 430 may dynamically adjust the distance range to the target electronic device to share files by pinch zoom.

The electronic device 420 may search for a nearest device to share files in response to the user's vertical zoom-out input on the touch display.

The electronic device 420 may search for a plurality of devices to share files in response to the user's vertical zoom-in input on the touch display. The plurality of devices may be displayed on the electronic device 420 based on the distance.

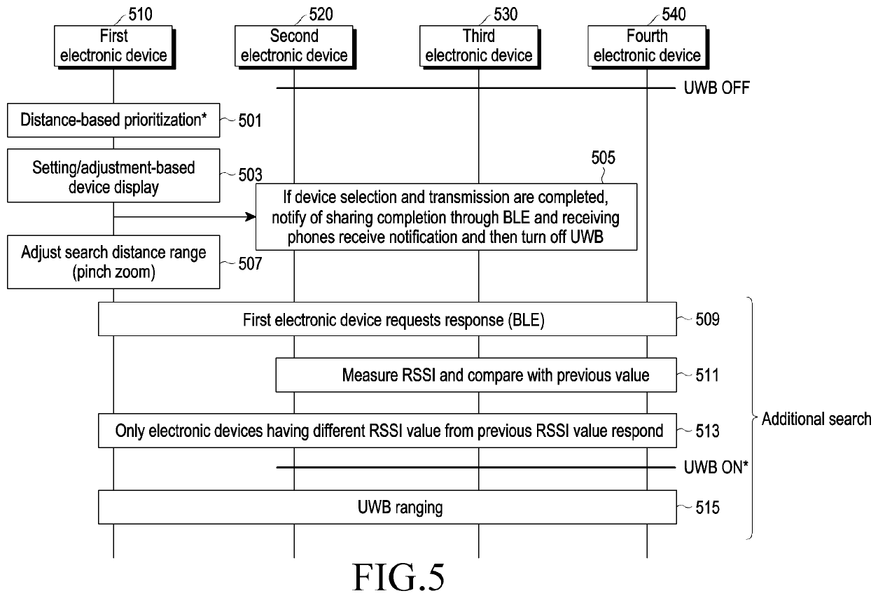

FIG. 5 illustrates a process in which an electronic device performs UWB ranging with at least one external electronic device according to an embodiment of the disclosure.

Each of the first electronic device 510, the second electronic device 520, the third electronic device 530, and the fourth electronic device 540 may be implemented as the electronic device 100 of FIG. 1, the first electronic device 210 of FIG. 2, the second electronic device 220 of FIG. 2, the first electronic device 301 of FIG. 3, or the second electronic device 302 of FIG. 3.

According to an embodiment, a UWB function (or a UWB module) for at least one of the second electronic device 520, the third electronic device 530, and the fourth electronic device 540 may be in an off state.

In operation 501, the first electronic device 510 may perform distance-based prioritization on the plurality of external electronic devices. According to an embodiment, the first electronic device 510 may perform distance-based prioritization using previous ranging values on an electronic device that has not received a BLE response after initial searching.

In operation 503, the first electronic device 510 may display an electronic device to provide or receive a service (e.g., file sharing) based on the setting and/or adjustment.

In operation 505, the first electronic device 510 may notify the completion of sharing via BLE communication when the device selection and transmission are completed, and at least one electronic device receiving the notification switches the UWB function (or UWB module) to an off state.

In operation 507, the first electronic device 510 may adjust a search distance range for an electronic device to provide or receive a service (e.g., file sharing) in response to the user's pinch zoom input.

In operation 509, the first electronic device 510 may request a response from each of the second electronic device 520, the third electronic device 530, and the fourth electronic device 540 via BLE communication. In operation 511, each of the second electronic device 520, the third electronic device 530, and the fourth electronic device 540 may measure a received signal strength indicator (RSSI) for the transmission signal of the first electronic device 510 and compare the RSSI measurement value with the previous RSSI measurement value.

In operation 513, when the RSSI measurement value is different from the previous RSSI measurement value, at least one of the second electronic device 520, the third electronic device 530, and the fourth electronic device 540 may transmit a response message to the first electronic device 510.

According to an embodiment, the UWB function (or UWB module) for at least one of the second electronic device 520, the third electronic device 530, and the fourth electronic device 540 may be switched to the on state.

In operation 515, the first electronic device 510 may perform UWB ranging based on the adjusted power level according to a new distance input with at least one of the second electronic device 520, the third electronic device 530, and the fourth electronic device 540.

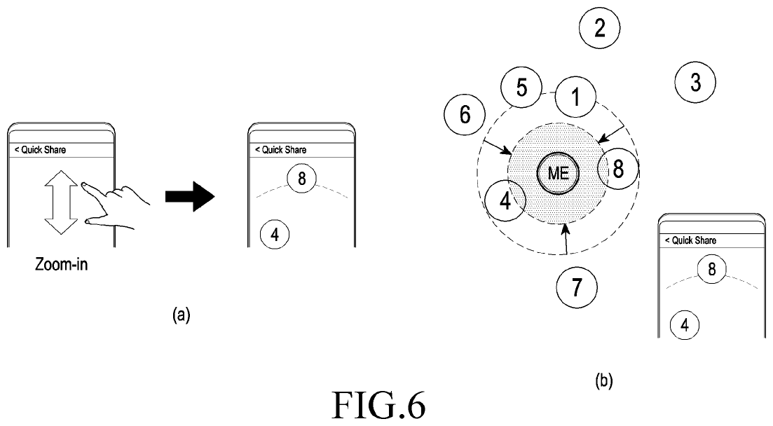

FIG. 6 illustrates an embodiment in which an electronic device performs a zoom-in operation, according to an embodiment of the disclosure.

In FIG. 6(a), the electronic device may, in response to the user's zoom-in input, search for external electronic devices to provide or receive a service (e.g., file sharing). The electronic device may reduce the number of the external electronic devices in response to the user's zoom-in input. For example, the electronic device may search for one external electronic device positioned at the closest distance in response to the user's zoom-in input.

In FIG. 6(b), when three external electronic devices 1, 4, and 8 are present within a set initial area and is to reduce the list, the electronic device may display two external electronic devices 4 and 8 within the reduced area in response to the user's zoom-in input.

The electronic device may display external electronic devices to provide or receive a service (e.g., file sharing) within the reduced area in response to the user's zoom-in input to perform UWB ranging with smaller transmission power (Tx) power.

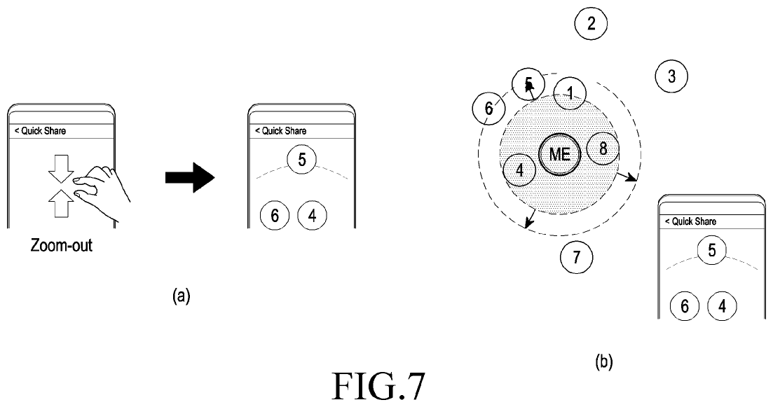

FIG. 7 illustrates an example in which an electronic device performs a zoom-out operation according to an embodiment of the disclosure.

In FIG. 7(a), the electronic device may search for external electronic devices to provide or receive a service (e.g., file sharing) in response to the user's zoom-out input. The electronic device may increase the number of the external electronic devices in response to the user's zoom-out input.

In FIG. 7(b), when three external electronic devices 1, 4, and 8 are present within a set initial area and is to enlarge the list, the electronic device may display four external electronic devices 1, 5, 4, and 8 within the enlarged area in response to the user's zoom-out input. According to an embodiment, when determining that the three external electronic devices 1, 4, and 8 within the set initial area are not the user's target device, the electronic device may preferentially list up the newly discovered electronic device 5 within the enlarged area.

When UWB ranging may be performed with a larger transmission (Tx) power, the electronic device may display external electronic devices to provide or receive a service (e.g., file sharing) within the enlarged area in response to the user's zoom-out input.

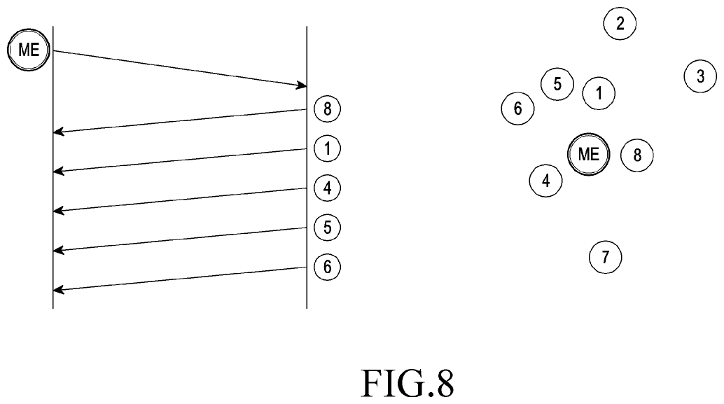

FIG. 8 illustrates an example of a process in which an electronic device performs SS-TWR, according to an embodiment of the disclosure.

Referring to FIG. 8, the electronic device ME may determine the distances between the electronic device ME and the external electronic devices based on the reception order of the response messages received through single-side two-way ranging (SS-TWR). According to an embodiment, the ranging mode of the SS-TWR follows the FiRa standard, the schedule mode may be set as content-based, and the multi-node mode may be set as one-to-many (multicast).

The electronic device ME may transmit a message in a one-to-many (multicast) manner, receive a response message from the electronic device 8, receive a response message from the electronic device 1, receive a response message from the electronic device 4, receive a response message from the electronic device 5, and receive a response message from the electronic device 6.

The electronic device ME may determine that the distances decrease in the order of the electronic device 8, the electronic device 1, the electronic device 4, the electronic device 5, and the electronic device 6 based on the order in which the response messages are received.

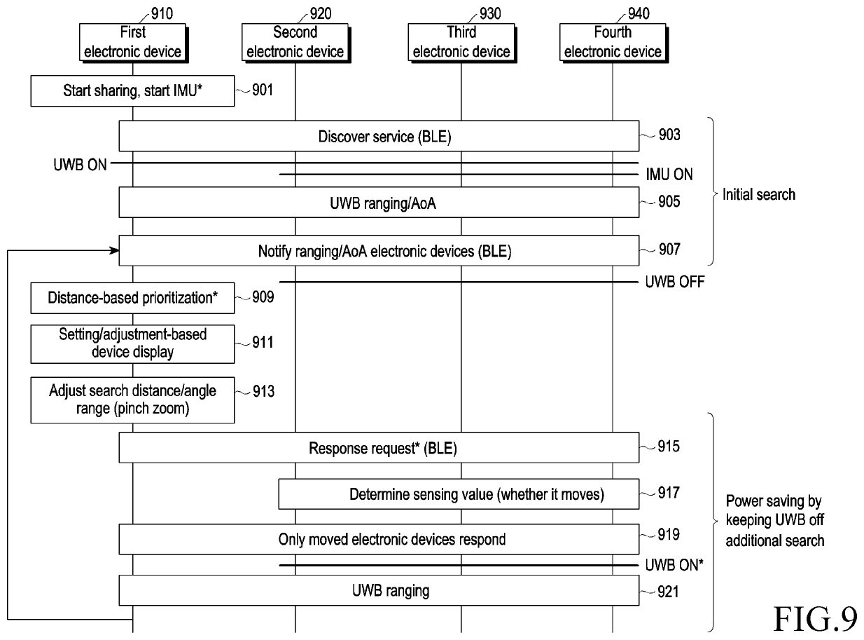

FIG. 9 illustrates a process in which a plurality of electronic devices perform sensing-based distance search according to an embodiment of the disclosure.

Each of the first electronic device 910, the second electronic device 920, the third electronic device 930, and the fourth electronic device 940 may be implemented as the electronic device 100 of FIG. 1, the first electronic device 210 of FIG. 2, the second electronic device 220 of FIG. 2, the first electronic device 301 of FIG. 3, or the second electronic device 302 of FIG. 3.

In operation 901, the first electronic device 910 may start a sharing service (e.g., file sharing) and drive an inertial measurement unit (IMU) sensor. According to an embodiment, when movement is detected before and after adjusting the search distance range, all of the electronic devices in the range in which the signal arrives may participate in UWB ranging.

Each of the first electronic device 910, the second electronic device 920, the third electronic device 930, and the fourth electronic device 940 may perform an initial search procedure. In operation 903, at least one of the first electronic device 910, the second electronic device 920, the third electronic device 930, and the fourth electronic device 940 may discover a service via BLE communication.

According to an embodiment, a UWB function (or a UWB module) for at least one of the first electronic device 910, the second electronic device 920, the third electronic device 930, and the fourth electronic device 940 may be switched to the on state. According to an embodiment, at least one of the second electronic device 920, the third electronic device 930, and the fourth electronic device 940 may drive the inertial measurement unit (IMU) sensor.

In operation 905, the first electronic device 910 may perform one-way ranging (OWR) for angle-of-arrival (AOA) and/or ranging with at least one of the second electronic device 920, the third electronic device 930, and the fourth electronic device 940 based on the reference power level.

In operation 907, the first electronic device 910 may transmit a notification via BLE communication to at least one electronic device that has undergone ranging and/or AoA.

According to an embodiment, the UWB function (or UWB module) for at least one of the second electronic device 920, the third electronic device 930, and the fourth electronic device 940 may be switched to the off state.

In operation 909, the first electronic device 910 may perform distance-based prioritization on the plurality of external electronic devices. According to an embodiment, the first electronic device 910 may perform distance-based prioritization using previous ranging values on an electronic device that has not received a BLE response after initial searching.

In operation 911, the first electronic device 910 may display an electronic device to provide or receive a service (e.g., file sharing) based on the setting and/or adjustment.

In operation 913, the first electronic device 910 may adjust the search distance and/or angle for the electronic device to provide or receive a service (e.g., file sharing) in response to the user's pinch zoom input.

Each of the first electronic device 910, the second electronic device 920, the third electronic device 930, and the fourth electronic device 940 may perform an additional search procedure. Through the additional search procedure, at least one of the first electronic device 910, the second electronic device 920, the third electronic device 930, and the fourth electronic device 940 may save power by maintaining the UWB off.

In operation 915, the first electronic device 910 may request a response from each of the second electronic device 920, the third electronic device 930, and the fourth electronic device 940 via BLE communication. According to an embodiment, if movement is detected, the first electronic device 910 may request the second electronic device 920, the third electronic device 930, and the fourth electronic device 940 to switch the UWB function (or UWB module) to the on state.

In operation 917, the second electronic device 920, the third electronic device 930, and the fourth electronic device 940 may each determine and/or track the IMU sensing value to determine whether each electronic device is moved.

In operation 919, when determining that the IMU sensing value has moved as a result of determination and/or tracking, at least one of the second electronic device 920, the third electronic device 930, and the fourth electronic device 940 may transmit a response message to the first electronic device 910.

According to an embodiment, if necessary, a UWB function (or a UWB module) for at least one of the second electronic device 920, the third electronic device 930, and the fourth electronic device 940 may be switched to the on state.

In operation 921, the first electronic device 910 may perform UWB ranging based on the adjusted power level according to a new distance input with at least one of the second electronic device 920, the third electronic device 930, and the fourth electronic device 940.

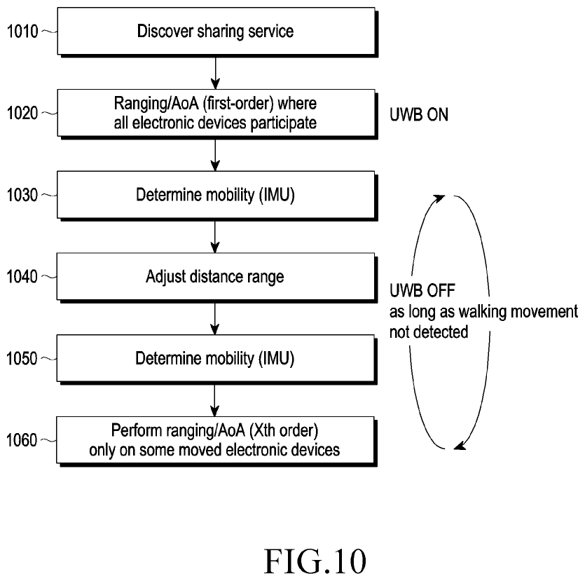

FIG. 10 illustrates a process in which an electronic device performs ranging and/or AoA during a sensing-based distance search according to an embodiment of the disclosure.

In operation 1010, the electronic device may discover a sharing service with at least one external electronic device via BLE communication. In operation 1020, ranging and/or AoA (first-order) in which all of the electronic devices participate may be performed. In operation 1020, all of the electronic devices may turn on the UWB module.

After performing ranging and/or AoA (first-order), the UWB module of electronic devices may switch to the off state until mobility (e.g., the user's walking motion) is detected.

In operation 1030, at least one external electronic device may determine the mobility of each of the external electronic devices using a sensor (e.g., an IMU sensor). In operation 1040, the electronic device may adjust the distance range for the external electronic device to be searched.

In operation 1050, at least one external electronic device may determine the respective mobility again using a sensor (e.g., an IMU sensor). In operation 1060, only some electronic devices detecting movement may perform ranging and/or AoA (xth-order).

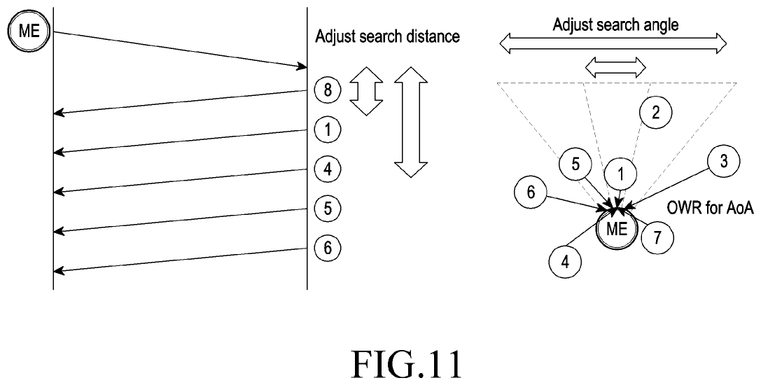

FIG. 11 illustrates a process in which an electronic device adjusts a search distance through SS-TWR according to an embodiment of the disclosure.

Referring to FIG. 11, the electronic device ME may determine and/or adjust the search distances between the electronic device ME and the external electronic devices based on the reception order of messages received through single-side two-way ranging (SS-TWR). The electronic device ME may determine and/or adjust the search angles between the electronic device ME and the external electronic devices based on the messages received through the OWR for AoA.

The electronic device ME may transmit a message in a one-to-many (multicast) manner, receive a response message from the electronic device 8, receive a response message from the electronic device 1, receive a response message from the electronic device 4, receive a response message from the electronic device 5, and receive a response message from the electronic device 6. The electronic device ME may determine that the distances decrease in the order of the electronic device 8, the electronic device 1, the electronic device 4, the electronic device 5, and the electronic device 6 based on the order in which the response messages are received.

The electronic device ME may receive a message from each of the electronic devices 1 to 7 through the OWR for AoA. The electronic device ME may adjust the search angle for each of the electronic devices 1 to 7 based on the message received through the OWR for AoA.

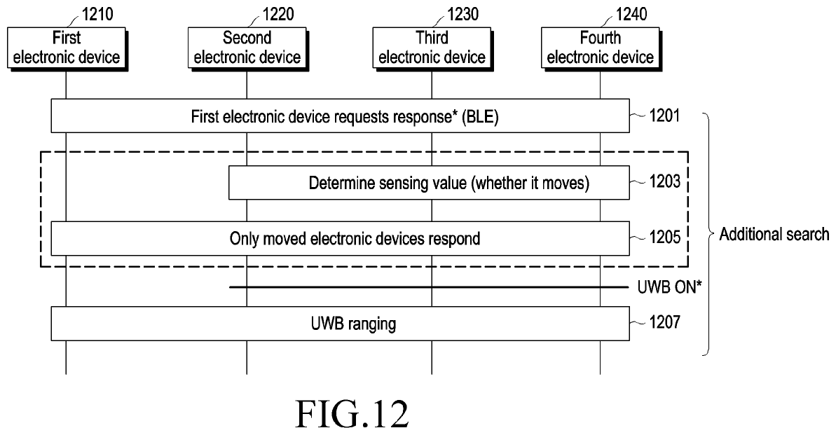

FIG. 12 illustrates a process in which an electronic device performs sensor-based search readjustment according to an embodiment of the disclosure.

Each of the first electronic device 1210, the second electronic device 1220, the third electronic device 1230, and the fourth electronic device 1240 may be implemented as the electronic device 100 of FIG. 1, the first electronic device 210 of FIG. 2, the second electronic device 220 of FIG. 2, the first electronic device 301 of FIG. 3, or the second electronic device 302 of FIG. 3.

When at least one of the second electronic device 1220, the third electronic device 1230, and the fourth electronic device 1240 determines whether the user moves using a sensor, there is a need to distinguish between the user's random movement and actual periodic walking.

At least one of the second electronic device 1220, the third electronic device 1230, and the fourth electronic device 1240 may determine that position movement has not occurred when the user does not have a periodic walking movement for a specific period of time, and maintain and/or switch the UWB module to the off state.

According to an embodiment, the walking frequency and the accelerometer amplitude (related to stride length) may be different for each user, and at least one of the second electronic device 1220, the third electronic device 1230, and the fourth electronic device 1240 may utilize sensor data collected for each user.

In operation 1201, the first electronic device 1210 may request a response from each of the second electronic device 1220, the third electronic device 1230, and the fourth electronic device 1240 via BLE communication.

In operation 1203, each of the second electronic device 1220, the third electronic device 1230, and the fourth electronic device 1240 may determine whether each electronic device is moved by determining and/or tracking the sensing value by a sensor.

In operation 1205, when determining that the corresponding electronic device has moved as a result of determining and/or tracking the sensing value, at least one of the second electronic device 1220, the third electronic device 1230, and the fourth electronic device 1240 may transmit a response message to the first electronic device 1210.

According to an embodiment, if necessary, a UWB function (or a UWB module) for at least one of the second electronic device 1220, the third electronic device 1230, and the fourth electronic device 1240 may be switched to the on state.

In operation 1207, the first electronic device 1210 may perform UWB ranging based on the adjusted power level according to a new distance input with at least one of the second electronic device 1220, the third electronic device 1230, and the fourth electronic device 1240.

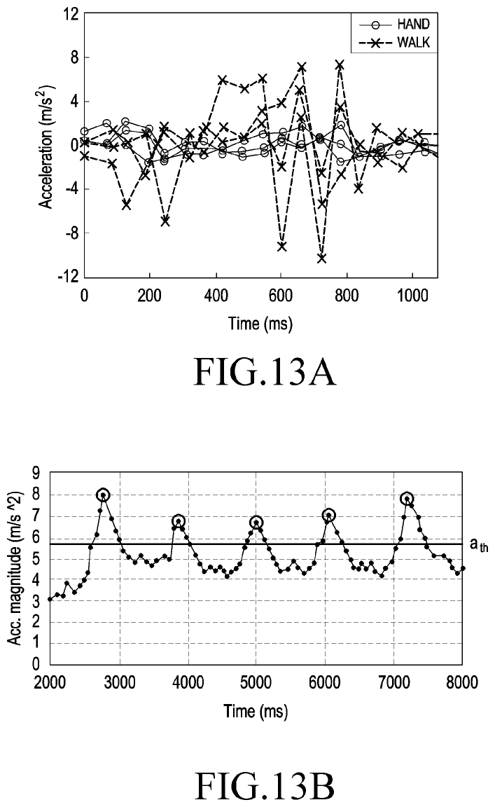

FIGS. 13A and 13B illustrate an example describing a process in which an electronic device determines mobility based on a sensor, according to an embodiment of the disclosure.

Referring to FIG. 13A, the electronic device may measure and/or track the acceleration of the electronic device based on a sensor and determine whether there is a periodic walking movement of the electronic device.

Referring to FIG. 13B, the electronic device may measure and/or track the acceleration of the corresponding electronic device based on a sensor, and compare the acceleration measurement value and a threshold aₜₕ. According to an embodiment, the electronic device may estimate the user's movement (e.g., stride) considering the case where the acceleration measurement value is larger than the threshold aₜₕ and forms a the peak value.

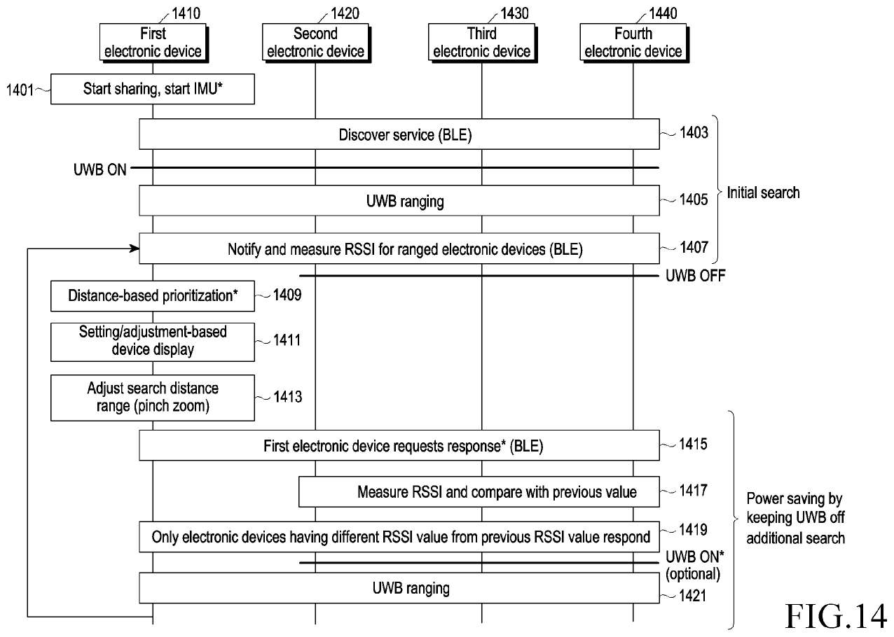

FIG. 14 illustrates a process in which a plurality of electronic devices perform BLE-based distance search according to an embodiment of the disclosure.

Each of the first electronic device 1410, the second electronic device 1420, the third electronic device 1430, and the fourth electronic device 1440 may be implemented as the electronic device 100 of FIG. 1, the first electronic device 210 of FIG. 2, the second electronic device 220 of FIG. 2, the first electronic device 301 of FIG. 3, or the second electronic device 302 of FIG. 3.

In operation 1401, the first electronic device 1410 may start a sharing service (e.g., file sharing) and drive an inertial measurement unit (IMU) sensor. According to an embodiment, when movement is detected before and after adjusting the search distance range, all of the electronic devices in the range in which the signal arrives may participate in UWB ranging.

Each of the first electronic device 1410, the second electronic device 1420, the third electronic device 1430, and the fourth electronic device 1440 may perform an initial search procedure. In operation 1403, at least one of the first electronic device 1410, the second electronic device 1420, the third electronic device 1430, and the fourth electronic device 1440 may discover a service via BLE communication.

According to an embodiment, a UWB function (or a UWB module) for at least one of the first electronic device 910, the second electronic device 920, the third electronic device 930, and the fourth electronic device 940 may be switched to the on state.

In operation 1405, the first electronic device 1410 may perform ranging with at least one of the second electronic device 1420, the third electronic device 1430, and the fourth electronic device 1440 based on the reference power level. In operation 1407, the first electronic device 1410 may transmit a notification via BLE communication to the at least one ranging electronic device, and the at least one electronic device may measure RSSI for the BLE signal.

According to an embodiment, at least one of the second electronic device 1420, the third electronic device 1430, and the fourth electronic device 1440 may perform BLE ranging-based (HADM) ranging for BLE-based mobility determination. According to an embodiment, at least one of the second electronic device 1420, the third electronic device 1430, and the fourth electronic device 1440 may combine and use BLE RSSI data for determining BLE-based mobility.

According to an embodiment, the UWB function (or UWB module) for at least one of the second electronic device 920, the third electronic device 930, and the fourth electronic device 940 may be switched to the off state.

In operation 1409, the first electronic device 1410 may perform distance-based prioritization on the plurality of external electronic devices. According to an embodiment, the first electronic device 1410 may perform distance-based prioritization using previous ranging values on an electronic device that has not received a BLE response after initial searching.

In operation 1411, the first electronic device 1410 may display an electronic device to provide or receive a service (e.g., file sharing) based on the setting and/or adjustment.

In operation 1413, the first electronic device 1410 may adjust the search distance and/or angle for the electronic device to provide or receive a service (e.g., file sharing) in response to the user's pinch zoom input.

Each of the first electronic device 1410, the second electronic device 1420, the third electronic device 1430, and the fourth electronic device 1440 may perform an additional search procedure. Through the additional search procedure, at least one of the first electronic device 1410, the second electronic device 1420, the third electronic device 1430, and the fourth electronic device 1440 may save power by maintaining the UWB off.

In operation 1415, the first electronic device 1410 may request a response from each of the second electronic device 1420, the third electronic device 1430, and the fourth electronic device 1440 via BLE communication.

According to an embodiment, if movement is detected, the first electronic device 1410 may request a response from each of the second electronic device 1420, the third electronic device 1430, and the fourth electronic device 1440. According to an embodiment, if movement is detected, the first electronic device 1410 may request the second electronic device 1420, the third electronic device 1430, and the fourth electronic device 1440 to switch the UWB function (or UWB module) to the on state.

In operation 1417, the second electronic device 1420, the third electronic device 1430, and the fourth electronic device 1440 may each determine and/or track the RSSI measurement value and compare the RSSI measurement value with the previous RSSI value.

In operation 1419, when it is determined that the RSSI measurement value is different from the previous RSSI measurement value, at least one of the second electronic device 1420, the third electronic device 1430, and the fourth electronic device 1440 may transmit a response message to the first electronic device 1410.

According to an embodiment, if necessary, a UWB function (or a UWB module) for at least one of the second electronic device 1420, the third electronic device 1430, and the fourth electronic device 1440 may be switched to the on state.

In operation 1421, the first electronic device 1410 may perform UWB ranging based on the adjusted power level according to a new distance input with at least one of the second electronic device 1420, the third electronic device 1430, and the fourth electronic device 1440.

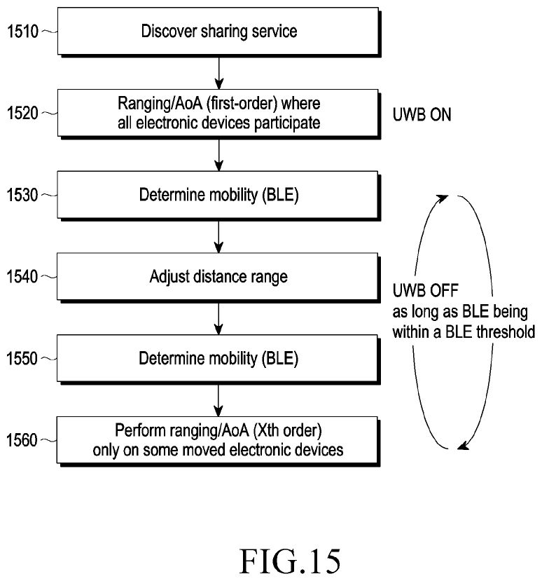

FIG. 15 illustrates a process in which an electronic device performs ranging and/or AoA during a BLE-based distance search according to an embodiment of the disclosure.

In operation 1510, the electronic device may discover a sharing service with at least one external electronic device via BLE communication. In operation 1520, ranging and/or AoA (first-order) in which all of the electronic devices participate may be performed. In operation 1520, all of the electronic devices may turn on the UWB module.

After performing ranging and/or AoA (first-order), the UWB module of electronic devices may switch to the off state until mobility (e.g., the user's walking motion) is detected.

In operation 1530, at least one external electronic device may determine the mobility of each of the external electronic devices using BLE communication. In operation 1540, the electronic device may adjust the distance range for the external electronic device to be searched.

In operation 1550, at least one external electronic device may determine the respective mobility again using BLE communication. In operation 1560, only some electronic devices detecting movement may perform ranging and/or AoA (xth-order).

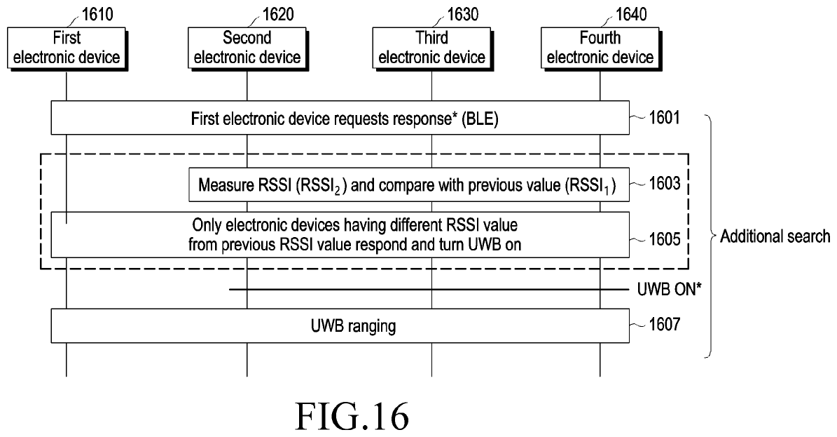

FIG. 16 illustrates a process in which an electronic device performs BLE-based search readjustment according to an embodiment of the disclosure.

Each of the first electronic device 1610, the second electronic device 1620, the third electronic device 1630, and the fourth electronic device 1640 may be implemented as the electronic device 100 of FIG. 1, the first electronic device 210 of FIG. 2, the second electronic device 220 of FIG. 2, the first electronic device 301 of FIG. 3, or the second electronic device 302 of FIG. 3.

When at least one of the second electronic device 1620, the third electronic device 1630, and the fourth electronic device 1640 readjusts the BLE-based search condition using the BLE RSSI, when the previous RSSI value RSSI 1 and the measurement RSSI value RSSI 2 are different from each other, it may be determined that the user's movement of the corresponding electronic device occurs.

According to an embodiment, at least one of the second electronic device 1620, the third electronic device 1630, and the fourth electronic device 1640 may perform a BLE RSSI data combination while UWB ranging is being performed.

According to an embodiment, at least one of the second electronic device 1620, the third electronic device 1630, and the fourth electronic device 1640 may collect UWB ranging and BLE RSSI data for each electronic device, and collect an RSSI distribution for each ranging distance. According to an embodiment, at least one of the second electronic device 1620, the third electronic device 1630, and the fourth electronic device 1640 may generate an RSSI threshold RSSIₜₕ based on the RSSI distribution. According to an embodiment, at least one of the second electronic device 1620, the third electronic device 1630, and the fourth electronic device 1640 may determine that there is no movement of the corresponding electronic device when the measurement RSSI value RSSI 2 is smaller than the RSSI threshold RSSIₜₕ.

In operation 1601, the first electronic device 1610 may request a response from each of the second electronic device 1620, the third electronic device 1630, and the fourth electronic device 1640 via BLE communication.

In operation 1603, each of the second electronic device 1620, the third electronic device 1630, and the fourth electronic device 1640 may measure and/or track the BLE RSSI value RSSI 2, and compare the previous RSSI value RSSI 1 with the measurement RSSI value RSSI 2.

In operation 1605, when the previous RSSI value RSSI 1 and the measurement RSSI value RSSI 2 are different, at least one of the second electronic device 1620, the third electronic device 1630, and the fourth electronic device 1640 may transmit a response message to the first electronic device 1610.

According to an embodiment, if necessary, a UWB function (or a UWB module) for at least one of the second electronic device 1620, the third electronic device 1630, and the fourth electronic device 1640 may be switched to the on state.

In operation 1607, the first electronic device 1610 may perform UWB ranging based on the adjusted power level according to a new distance input with at least one of the second electronic device 1620, the third electronic device 1630, and the fourth electronic device 1640.

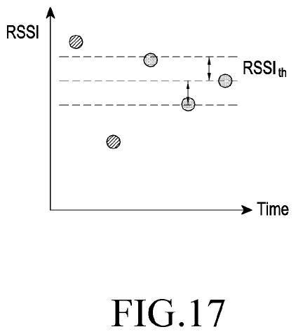

FIG. 17 illustrates an example for describing a process in which an electronic device determines mobility based on BLE, according to an embodiment of the disclosure.

The electronic device may generate and/or set a range for the RSSI threshold RSSIₜₕ based on the RSSI distribution. According to an embodiment, the electronic device may measure a plurality of BLE RSSI values and generate and/or set a range for the RSSI threshold RSSIₜₕ based thereon.

When the electronic device measures an RSSI measurement value outside the range for the RSSI threshold RSSIₜₕ, the electronic device may determine that there is a movement of the electronic device, and switch the UWB module to the on state.

When the electronic device measures an RSSI measurement value in the range for the RSSI threshold RSSIₜₕ, the electronic device may determine that the corresponding electronic device is positioned at the same position, and switch the UWB module to the off state.

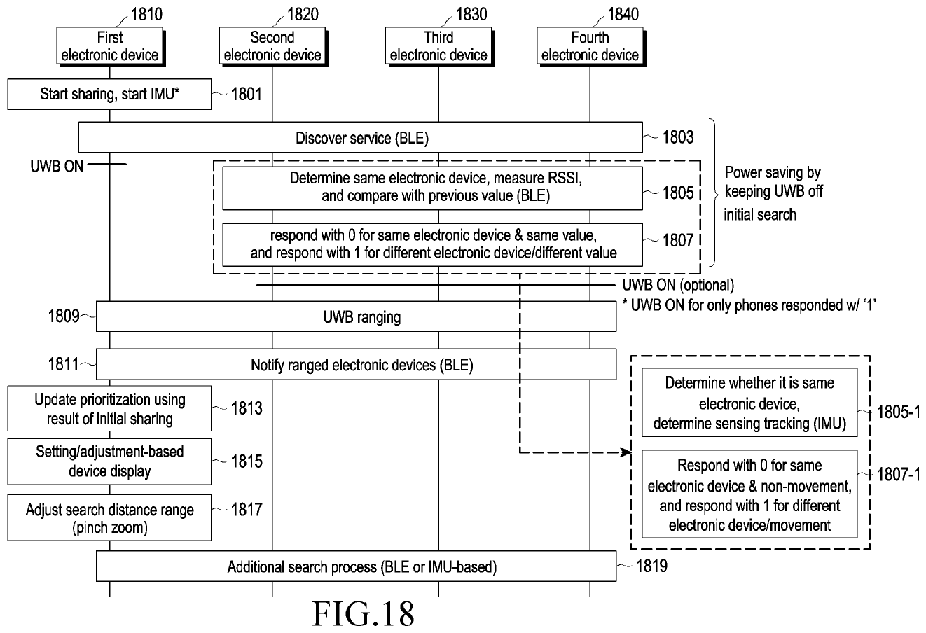

FIG. 18 illustrates a process in which a plurality of electronic devices perform an initial sharing-based additional sharing distance search, according to an embodiment of the disclosure.

Each of the first electronic device 1810, the second electronic device 1820, the third electronic device 1830, and the fourth electronic device 1840 may be implemented as the electronic device 100 of FIG. 1, the first electronic device 210 of FIG. 2, the second electronic device 220 of FIG. 2, the first electronic device 301 of FIG. 3, or the second electronic device 302 of FIG. 3.

In operation 1801, the first electronic device 1810 may start a sharing service (e.g., file sharing) and drive an inertial measurement unit (IMU) sensor. According to an embodiment, when movement is detected before and after adjusting the search distance range, all of the electronic devices in the range in which the signal arrives may participate in UWB ranging.

Each of the first electronic device 1810, the second electronic device 1820, the third electronic device 1830, and the fourth electronic device 1840 may perform an initial search procedure. In operation 1803, at least one of the first electronic device 1810, the second electronic device 1820, the third electronic device 1830, and the fourth electronic device 1840 may discover a service via BLE communication.

In operation 1805, at least one of the second electronic device 1820, the third electronic device 1830, and the fourth electronic device 1840 may determine whether it is the same BLE signal transmission device as the previous BLE signal, and compare the BLE RSSI measurement value with the previous RSSI value.

In operation 1807, if at least one of the second electronic device 1820, the third electronic device 1830, and the fourth electronic device 1840 is the same BLE signal transmission device as the previous BLE signal, and the BLE RSSI measurement value and the previous RSSI value are the same, it may transmit a response including a preset value (e.g., “0”) to the first electronic device 1810.

In operation 1807, at least one of the second electronic device 1820, the third electronic device 1830, and the fourth electronic device 1840 may transmit a response including the preset value (e.g., “1”) to the first electronic device 1810 if it is not the same BLE signal transmission device as the previous BLE signal or if the BLE RSSI measurement value is not the same as the previous RSSI value.

According to an embodiment, in operation 1805-1, at least one of the second electronic device 1820, the third electronic device 1830, and the fourth electronic device 1840 may determine whether it is the same BLE signal transmission device as the previous BLE signal, and measure and track the sensing value by a sensor.

According to an embodiment, in operation 1807-1, if at least one of the second electronic device 1820, the third electronic device 1830, and the fourth electronic device 1840 is the same BLE signal transmission device as the previous BLE signal, and there is no movement of the corresponding electronic device as a result of tracking the sensing value, it may transmit a response including a preset value (e.g., “0”) to the first electronic device 1810.

According to an embodiment, in operation 1807-1, at least one of the second electronic device 1820, the third electronic device 1830, and the fourth electronic device 1840 may transmit a response including a preset value (e.g., “1”) to the first electronic device 1810 if it is not the same BLE signal transmission device as the previous BLE signal or if the corresponding electronic device moves as a result of tracking the sensing value.

According to an embodiment, the UWB function (or UWB module) for at least one of the second electronic device 1820, the third electronic device 1830, and the fourth electronic device 1840 may be switched to the on state.

According to an embodiment, the first electronic device 1810 may maintain the previous ranging value and priority information for at least one of the second electronic device 1820, the third electronic device 1830, and the fourth electronic device 1840 for a predetermined time (e.g., when remaining without movement based on IMU sensing).

According to an embodiment, at least one of the second electronic device 1820, the third electronic device 1830, and the fourth electronic device 1840 may maintain the previous BLE RSSI information for a predetermined time (e.g., when IMU sensing starts and remains without movement when sharing is accepted).

In operation 1809, the first electronic device 1810 may perform ranging with at least one of the second electronic device 1820, the third electronic device 1830, and the fourth electronic device 1840 based on the reference power level. In operation 1811, the first electronic device 1810 may transmit a notification via BLE communication to the at least one electronic device that has undergone ranging.

In operation 1813, the first electronic device 1810 may update distance-based prioritization for the plurality of external electronic devices using the initial sharing result.

In operation 1815, the first electronic device 1810 may display an electronic device to provide or receive a service (e.g., file sharing) based on the setting and/or adjustment.

In operation 1817, the first electronic device 1810 may adjust the search distance and/or angle for the electronic device to provide or receive a service (e.g., file sharing) in response to the user's pinch zoom input.

In operation 1819, at least one of the first electronic device 1810, the second electronic device 1820, the third electronic device 1830, and the fourth electronic device 1840 may perform an additional search procedure based on BLE or IMU. Through the additional search procedure, at least one of the first electronic device 1810, the second electronic device 1820, the third electronic device 1830, and the fourth electronic device 1840 may save power by maintaining the UWB off.

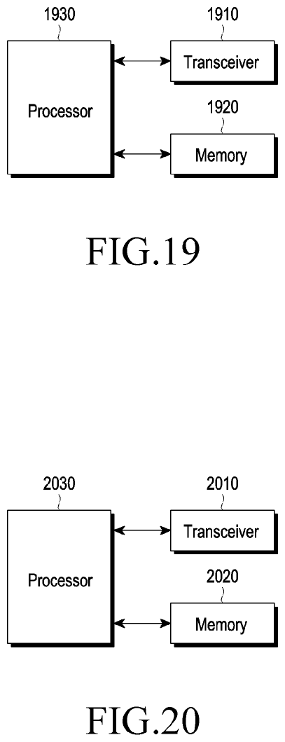

FIG. 19 illustrates a structure of a first electronic device according to an embodiment of the disclosure.

The first electronic device of FIG. 19 may be implemented as the first electronic device 510 of FIG. 5, the first electronic device 910 of FIG. 9, the first electronic device 1210 of FIG. 12, the first electronic device 1410 of FIG. 14, the first electronic device 1610 of FIG. 16, or the first electronic device 1810 of FIG. 18.

Referring to FIG. 19, the first electronic device may include a transceiver 1910, memory 1920, and a processor 1930.

The transceiver 1910, processor 1930, and memory 1920 of the first electronic device may be operated according to the communication method of the electronic devices. However, the components of the first electronic device are not limited thereto. For example, the first electronic device may include more or fewer components than the above-described components. Further, the transceiver 1910, the processor 1930, and the memory 1920 may be implemented in the form of a single chip. The processor 1930 may include one or more processors.

The transceiver 1910 collectively refers to a receiver of the first electronic device and a transmitter of the first electronic device and may transmit and receive signals to/from another device. The transceiver 1910 may also be referred to as a transmission/reception unit. The transceiver 1910 may include an RF transmitter for frequency-up converting and amplifying signals transmitted and an RF receiver for low-noise amplifying signals received and frequency-down converting the frequency of the received signals. However, this is merely an embodiment of the transceiver 1910, and the components of the transceiver 1910 are not limited to the RF transmitter and the RF receiver.

The transceiver 1910 may receive signals via a radio channel, output the signals to the processor 1930, and transmit signals output from the processor 1930 via a radio channel.

The memory 1920 may store programs and data necessary for the operation of the first electronic device. Further, the memory 1920 may store control information or data that is included in the signal obtained by the first electronic device. The memory 1920 may include a storage medium, such as ROM, RAM, hard disk, CD-ROM, and DVD, or a combination of storage media. Rather than being separately provided, the memory 1920 may be embedded in the processor 1930.

The processor 1930 may control a series of processes for the first electronic device to be able to operate according to the above-described embodiments of the disclosure. The processor 1930 may be referred to as a controller.

According to an embodiment, the processor 1930 may control to transmit a first message via Bluetooth low energy (BLE) communication to at least one external electronic device that has performed first UWB ranging with the electronic device. According to an embodiment, the processor 1930 may adjust at least one of a discovery distance and a discovery angle for external electronic devices in response to a user input.

According to an embodiment, the processor 1930 may control to transmit a second message to the external electronic devices via the BLE based on a result of the adjustment. According to an embodiment, the processor 1930 may receive a third message corresponding to the second message from at least one of the external electronic devices. According to an embodiment, the processor 1930 may perform second UWB ranging with the at least one external electronic device that transmitted the third message.

According to an embodiment, the user input may be a zoom-in input or a zoom-out input.

According to an embodiment, the processor 1930 may control to transmit a message requesting a UWB module of the at least one external electronic device that transmitted the third message to be turned on.

According to an embodiment, the processor 1930 may display the external electronic devices for which at least one of the discovery distance and the discovery angle has been adjusted in response to the user input.

FIG. 20 illustrates a structure of a second electronic device according to an embodiment of the disclosure.

The first electronic device of FIG. 20 may be implemented as one of the second to fourth electronic devices of FIG. 5 (any one of 520 to 540), one of the second to fourth electronic devices of FIG. 9 (any one of 920 to 940), one of the second to fourth electronic devices of FIG. 12 (any one of 1220 to 1240), one of the second to fourth electronic devices of FIG. 14 (any one of 1420 to 1440), one of the second to fourth electronic devices of FIG. 16 (any one of 1620 to 1640), or one of the second to fourth electronic devices of FIG. 20 (any one of 2020 to 2040).

Referring to FIG. 20, the second electronic device may include a transceiver 2010, memory 2020, and a processor 2030.

The transceiver 2010, processor 2030, and memory 2020 of the second electronic device may be operated according to the communication method of the electronic devices. However, the components of the second electronic device are not limited thereto. For example, the second electronic device may include more or fewer components than the above-described components. Further, the transceiver 2010, the processor 2030, and the memory 2020 may be implemented in the form of a single chip. The processor 2030 may include one or more processors.

The transceiver 2010 collectively refers to a receiver of the second electronic device and a transmitter of the second electronic device and may transmit and receive signals to/from another device. The transceiver 2010 may also be referred to as a transmission/reception unit. The transceiver 2010 may include an RF transmitter for frequency-up converting and amplifying signals transmitted and an RF receiver for low-noise amplifying signals received and frequency-down converting the frequency of the received signals. However, this is merely an embodiment of the transceiver 2010, and the components of the transceiver 2010 are not limited to the RF transmitter and the RF receiver.

The transceiver 2010 may receive signals via a radio channel, output the signals to the processor 2030, and transmit signals output from the processor 2030 via a radio channel.

The memory 2020 may store programs and data necessary for the operation of the second electronic device. Further, the memory 2020 may store control information or data that is included in the signal obtained by the second electronic device. The memory 2020 may include a storage medium, such as ROM, RAM, hard disk, CD-ROM, and DVD, or a combination of storage media. Rather than being separately provided, the memory 2020 may be embedded in the processor 2030.

The processor 2030 may control a series of processes for the second electronic device to be able to operate according to the above-described embodiments of the disclosure. The processor 2030 may be referred to as a controller.

According to an embodiment, the processor 2030 may receive a first message via Bluetooth low energy (BLE) communication from an external electronic device that has performed first UWB ranging. According to an embodiment, the processor 2030 may receive a second message via the BLE communication from the external electronic device if at least one of a discovery distance and a discovery angle of the external electronic device is adjusted in response to a user input of the external electronic device.

According to an embodiment, the processor 2030 may determine whether the electronic device has moved based on a sensor measurement value or a BLE received signal strength indicator (RSSI) value. According to an embodiment, the processor 2030 may control to transmit a third message corresponding to the second message to the external electronic device if it is determined that the electronic device has moved. According to an embodiment, the processor 2030 may perform second UWB ranging with the external electronic device.

According to an embodiment, in claim 5, the user input may be a zoom-in input or a zoom-out input.

According to an embodiment, the processor 2030 may turn off a UWB module of the electronic device if receiving the first message. According to an embodiment, the processor 2030 may turn on a UWB module of the electronic device after transmitting the third message to the external electronic device.

According to an embodiment, the processor 2030 may compare the sensor measurement value with a threshold. According to an embodiment, the processor 2030 may determine that the electronic device has moved if the sensor measurement value exceeds the threshold a preset number of times during a preset time interval.

According to an embodiment, the processor 2030 may determine whether the BLE RSSI value falls within a threshold range. According to an embodiment, the processor 2030 may determine that the electronic device has moved if the BLE RSSI value is outside the threshold range.

In the above-described specific embodiments of the present invention, the components included in the disclosure are represented in singular or plural forms depending on specific embodiments proposed. However, the singular or plural forms are selected to be adequate for contexts suggested for ease of description, and the present invention is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for operating an electronic device supporting ultra-wideband (UWB) communication, the method comprising:
transmitting, via Bluetooth low energy (BLE) communication, a first message to at least one external electronic device that has performed first UWB ranging with the electronic device;
adjusting at least one of a discovery distance and a discovery angle for external electronic devices in response to a user input;
transmitting, via the BLE communication, a second message to the external electronic devices based on a result of the adjustment;
receiving a third message corresponding to the second message from at least one external electronic device among the external electronic devices; and
performing second UWB ranging with the at least one external electronic device that transmitted the third message.

2. The method of claim 1, wherein the user input is a zoom-in input or a zoom-out input.

3. The method of claim 1, further comprising transmitting a message requesting a UWB module of the at least one external electronic device that transmitted the third message to be turned on.

4. The method of claim 1, further comprising:
displaying the external electronic devices for which at least one of the discovery distance and the discovery angle has been adjusted in response to the user input.

5. A method for operating an electronic device supporting ultra-wideband (UWB) communication, the method comprising:
receiving, via Bluetooth low energy (BLE) communication, a first message from an external electronic device that has performed first UWB ranging;
receiving, via the BLE communication, a second message from the external electronic device based on at least one of a discovery distance and a discovery angle of the external electronic device being adjusted in response to a user input of the external electronic device;
determining whether the electronic device has moved based on a sensor measurement value or a BLE received signal strength indicator (RSSI) value;
transmitting a third message corresponding to the second message to the external electronic device based on determining that the electronic device has moved; and
performing second UWB ranging with the external electronic device.

6. The method of claim 5, wherein the user input is a zoom-in input or a zoom-out input.

7. The method of claim 5, further comprising:
turning off a UWB module of the electronic device based on receiving the first message.

8. The method of claim 5, further comprising:
turning on a UWB module of the electronic device after transmitting the third message to the external electronic device.

9. The method of claim 5, further comprising:
comparing the sensor measurement value with a threshold; and
determining that the electronic device has moved based on the sensor measurement value exceeding the threshold a preset number of times during a preset time interval.

10. The method of claim 5, further comprising:
determining whether the BLE RSSI value falls within a threshold range; and
determining that the electronic device has moved based on the BLE RSSI value being outside the threshold range.

11. An electronic device supporting ultra-wideband (UWB) communication, comprising:
a transceiver; and
a processor, wherein the processor is configured to:
control to transmit, via Bluetooth low energy (BLE) communication, a first message to at least one external electronic device that has performed first UWB ranging with the electronic device;
adjust at least one of a discovery distance and a discovery angle for external electronic devices in response to a user input;
control to transmit, via the BLE communication, a second message to the external electronic devices based on a result of the adjustment;
receive a third message corresponding to the second message from at least one external electronic device among the external electronic devices; and
perform second UWB ranging with the at least one external electronic device that transmitted the third message.

12. The electronic device of claim 11, wherein the user input is a zoom-in input or a zoom-out input.

13. An electronic device supporting ultra-wideband (UWB) communication, comprising:
a transceiver; and
a processor, wherein the processor is configured to:
receive, via Bluetooth low energy (BLE) communication, a first message from an external electronic device that has performed first UWB ranging;
receive, via the BLE communication, a second message from the external electronic device based on at least one of a discovery distance and a discovery angle of the external electronic device being adjusted in response to a user input of the external electronic device;
determine whether the electronic device has moved based on a sensor measurement value or a BLE received signal strength indicator (RSSI) value;
control to transmit a third message corresponding to the second message to the external electronic device based on determining that the electronic device has moved; and
perform second UWB ranging with the external electronic device.

14. The electronic device of claim 13, wherein the processor is configured to:
compare the sensor measurement value with a threshold; and
determine that the electronic device has moved based on the sensor measurement value exceeding the threshold a preset number of times during a preset time interval.

15. The electronic device of claim 13, wherein the processor is configured to:
determine whether the BLE RSSI value falls within a threshold range; and
determine that the electronic device has moved based on the BLE RSSI value being outside the threshold range.
